(19) United States
(12) Patent Application Publication
(10) Pub. No.: US 2011/0006986 A1
(43) Pub. Date: Jan. 13, 2011

(54) INPUT DEVICE

(75) Inventor: Atsuhito Iemura, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: KYOCERA CORPORATION, Kyoto (JP)

(21) Appl. No.: 12/671,203

(22) PCT Filed: Jul. 30, 2008
(86) PCT No.: PCT/JP2008/063707

§ 371 Date: Sep. 23, 2010

(30) Foreign Application Priority Data
Jul. 30, 2007 (JP) 2007-198203

(51) Int. Cl. G06F 3/02; G06F 3/033

(52) U.S. Cl. 345/160; 345/168; 345/172

(57) ABSTRACT

Provided is an input device, the operability of which can be VEHICLE improved by enabling efficient character input and function execution. A main controller (121) generates character codes corresponding to a plurality of different character types assigned to a character input key (14) that has been pressed down. The generated character codes of the different character types are stored in a RAM (121b) and each of the character codes read from the RAM (121b) is converted to each character code by a character generator ROM (117a). The converted character codes of the different character types are displayed on the same screen of a display (21).

### TECHNICAL FIELD

The present invention relates to an input device, and for example, relates to an input device that is capable of providing efficient character input and function execution for a split screen.

### BACKGROUND ART

In conventional cellular telephone devices, techniques such as a technique in which a mail function and the like are activated and a text such as a memo is written and saved into a memo pad by using a character input function, and a technique in which a sentence is described in a text to transmit a mail are known as publicly known techniques.

In conventional character input functions, the functions have been configured such that the user firstly activates a function for performing a character input such as, for example, a memo pad function, and then performs a character input. In the conventional cellular telephone devices, for example, in a case in which a memo pad function is invoked, it is necessary to perform invocation operations in five steps from “standby screen” to “main menu” to “convenient function” to “memo pad” and to “new creation”.

Moreover, Patent Document 1 discloses a technique in which two existing sentences are read and displayed on a split screen, and are edited as one sentence. In addition, Patent Document 2 discloses a technique in which an area of a screen is separated to be selected, thereby facilitating movement of a pointer on the screen.

Patent Document 1: Japanese Unexamined Patent Application, First Publication No. H5-342206

Patent Document 2: Japanese Unexamined Patent Application, First Publication No. 2002-14773

### DISCLOSURE OF THE INVENTION

### Problems to be Solved by the Invention

However, in the conventional character input functions, the functions have been configured such that the user firstly activates a function for performing a character input, and then performs a character input. Therefore, in a case in which the user desires to make a quick memo during a telephone call, the user is firstly required to invoke a memo pad function, and it is conceivable that the user forgets the contents of the memo that was going to be made, while performing invocation operations in multiple steps.

In this way, in conventional cellular telephone devices, in a case in which characters are input in order to perform a predetermined function (for example, memo creation, mail creation and the like), a desired function is activated in advance, and then an input of characters (sentence, destination and the like) is performed; therefore, complicated key operations have been required. Accordingly, the operability for the user has been impaired in some cases.

The present invention has been made in view of the above, and the object thereof is to provide an input device that enables efficient character input and function execution and can improve the operability.

### Means for Solving the Problems

In order to solve the abovementioned problems, an input device according to the present invention includes: a first generating means for generating input information corresponding to at least two input types assigned to a key operated, respectively; a second generating means for generating image information corresponding to the input information, respectively; and a displaying means for displaying an image on a screen which is identical based on the image information, respectively.

Moreover, it is preferable that the input device further includes: a detecting means for detecting that a function key for instructing execution of a predetermined function is operated, the function key corresponding to the image being displayed; and a first executing means for executing, based on detection of an operation of the function key, the predetermined function that is based on the input information of the image.

In addition, it is preferable that the input device further includes a first changing means for changing the predetermined function, based on an operation time of the function key.

Furthermore, it is preferable that the input device further includes: a character type selection key for selecting a character type displayed on the screen; and a second executing means for executing, in a case in which a character type is selected by an operation of the character type selection key, a predetermined function corresponding to the character type thus selected.

Moreover, it is preferable that the input device further includes: a cursor for selecting a character type displayed on the screen; and a third executing means for executing, in a case in which a character type is selected by way of an input from the cursor, a function that is executed together with the character type, in which the displaying means displays a character type as well as a function that is executed in a case in which the character type is selected.

In order to solve the abovementioned problems, it is preferable that the input device according to the present invention further includes: a selecting means for selecting any image among images displayed on the screen; a second changing means for changing display of at least one softkey displayed on the screen, based on selection by way of the selecting means; and a third executing means for executing a function of the softkey based on input information of the image thus selected, by way of an operation of a key corresponding to display of the softkeys.

In addition, in the input device, it is preferable that the input types include at least one input type among a hiragana character, a numeric character, an alphabetic character, a katakana character and a symbol.

Furthermore, it is preferable that the input device further includes a setting means for setting an input type to be displayed on the screen from among the input types.

Moreover, in the input device, it is preferable that a screen that displays the image or a screen that is immediately before displaying the image is a standby screen waiting for an input from a user.

### Effects of the Invention

According to the present invention, efficient character input and function execution are enabled, and the operability can be improved.

### BRIEF DESCRIPTION OF THE DRAWINGS

FIG. 1 is a perspective view showing an appearance of a cellular telephone device 1 as an example of a portable terminal device according to the present invention;

FIG. 2 is a perspective view showing a state in which the cellular telephone device 1 is folded;

FIG. 3 is an exploded perspective view of members built into an operation unit side body 2;

FIG. 4 is an exploded perspective view of members built into a display unit side body 3;

FIG. 5A is a diagram showing an arrangement plan (part 1) of keys provided on a front panel 2a of the operation unit side body 2;

FIG. 5B is a diagram showing an enlarged arrangement plan (part 2) of a numeric key portion of the keys provided on the front panel 2a of the operation unit side body 2;

FIG. 6 is a block diagram illustrating functions of the cellular telephone device 1;

FIG. 7 is a flowchart illustrating a first embodiment of the present invention;

FIG. 8 is a diagram showing a numeric code, a hiragana code, an alphabetic code, a katakana code, a symbolic code and other codes stored in ROM 121a;

FIG. 9 is a diagram showing images of different characters displayed on a display area 21a of a display unit 21;

FIG. 10 is a flowchart showing a subroutine for executing function processing of the cellular telephone device 1;

FIG. 11 is a flowchart illustrating a second embodiment of the present invention;

FIG. 12 is a flowchart showing a subroutine for executing function processing of the cellular telephone device 1;

FIG. 13 is a flowchart illustrating a third embodiment of the present invention;

FIG. 14 is a diagram showing images of different characters displayed on the display area 21a of the display unit 21;

FIG. 15 is a flowchart showing a subroutine for executing function processing of the cellular telephone device 1;

FIG. 16 is a flowchart illustrating a fourth embodiment of the present invention;

FIG. 17 is a flowchart showing a subroutine for executing function processing of the cellular telephone device 1;

FIG. 18 is a diagram showing images of characters of different character types and function softkeys corresponding to the character types, which are displayed on the display area 21a of the display unit 21; and

FIG. 19 is a diagram showing contents of a function softkey table referred by a main control unit 121.

### EXPLANATION OF REFERENCE NUMERALS

21 display unit

101 antenna unit

103 telephone call receiving unit

105 outgoing telephone call unit

107 mail receiving unit

109 mail transmitting unit

111 browsing unit

113 operation input unit

115 input data acquisition unit

117 display control unit

117a character generator ROM

119 VRAM

121 main control unit

121a ROM

121b RAM

121c CPU

### PREFERRED MODE FOR CARRYING OUT THE INVENTION

Embodiments of the present invention are hereinafter described with reference to the drawings. It should be noted that, although a cellular telephone device is hereinafter described as an example of a portable terminal device, the present invention is not limited thereto, and it may be other portable terminal devices such as a PHS (Personal Handyphone System), PDA (Personal Digital Assistant), a portable navigation device, and a notebook computer.

### First Embodiment

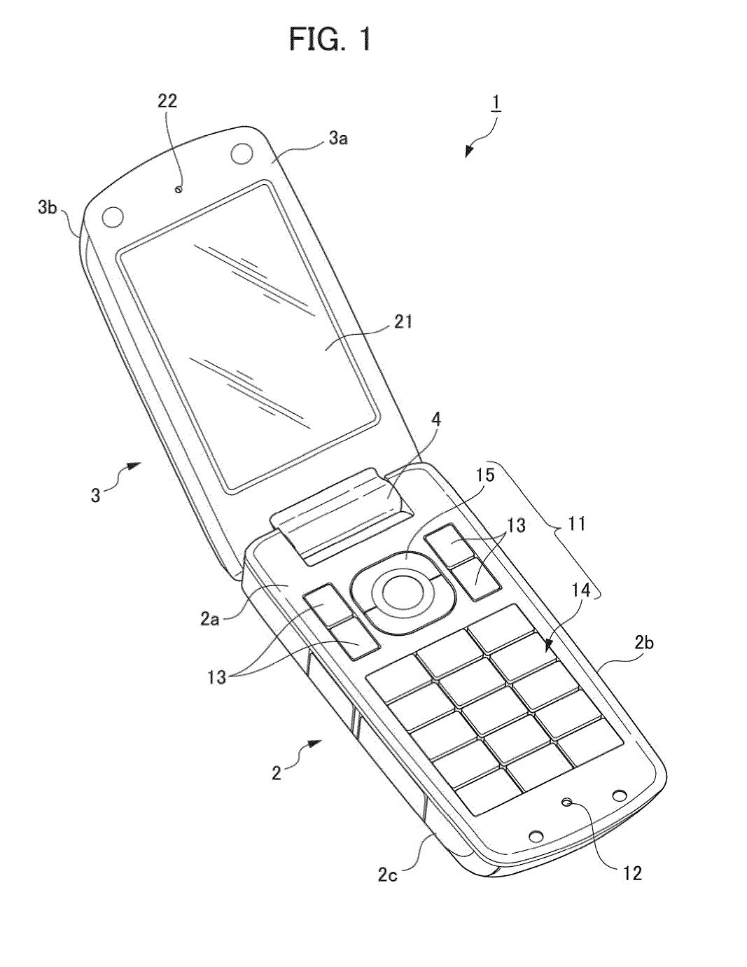

FIG. 1 is a perspective view showing an appearance of a cellular telephone device 1 as an example of a portable terminal device according to the present invention.

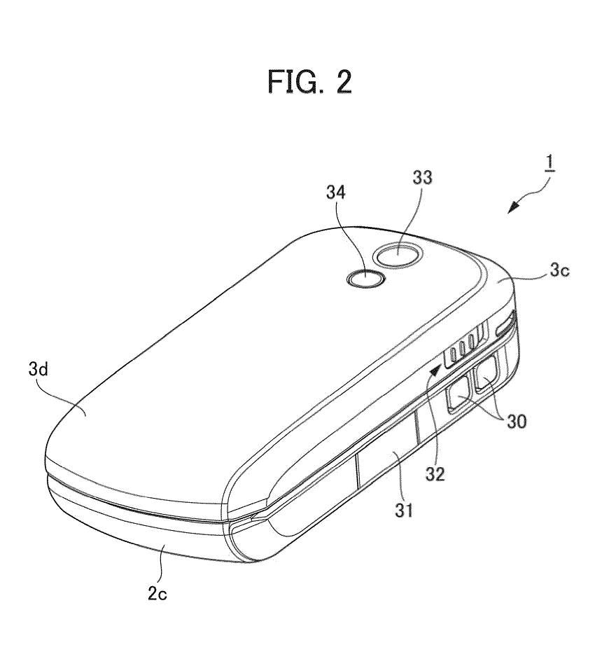

The cellular telephone device 1 includes: an operation unit side body 2 (first body), a surface of which is configured with a front case 2a, a front panel 2b, a rear case 2c and a rear panel 2d (not shown); and a display unit side body 3 (second body), a surface of which is configured with a front panel 3a, a front case 3b, a rear case 3c (FIG. 2) and a rear panel 3d (FIG. 2).

An operation key set 11 and a sound input unit 12, to which sound produced by a user of the cellular telephone device 1 during a phone call is input, are exposed on a surface of the front panel 2a of the operation unit side body 2. The operation key set 11 is configured with: function setting operation keys 13 for operating various functions such as for various settings, a telephone number directory function and a mail function; character input keys 14 for inputting digits of a telephone number and characters for mail, etc.; and a selection operation key 15 for performing selection of the various operations and scrolling, etc. A cap covering the interface to communicate with an external device (for example, a host device) is provided on a side face of the operation unit side body 2.

A display unit 21 for displaying a variety of information and a sound output unit 22 for outputting sound of the other party of a conversation are exposed on the front panel 3a of the display unit side body 3.

As shown in FIG. 1, an upper end portion of the operation unit side body 2 and a lower end portion of the display unit side body 3 are connected via a hinge mechanism (connecting portion) 4. In other words, the hinge mechanism 4 pivotally connects one end side (upper end portion) of the operation unit side body 2 and one end side (lower end portion) of the display unit side body 3. Moreover, by relatively moving the operation unit side body 2 and the display unit side body 3 connected via the hinge mechanism 4, the cellular telephone device 1 can be in a state where the operation unit side body 2 and the display unit side body 3 are contacting each other (a first state or a folded state where the bodies are superimposed with each other), and in a state where the operation unit side body 2 and the display unit side body 3 are apart from each other (a second state or an opened state where the degree of mutual superimposition is lower than that of the folded state). It should be noted that, although the cellular telephone device 1 that is foldable via the hinge mechanism 4 is described in the present embodiment, instead of such a flip type, the cellular telephone device 1 may be of: a slider type in which one body slides to one direction from a state in which both of the bodies 2 and 3 are mutually superimposed; a rotating type in which one body is rotated around an axis line along the direction of the superimposition; a type in which both of the bodies 2 and 3 are connected via a 2-axis hinge; or a straight type that is not foldable.

FIG. 2 is a perspective view showing a state in which the cellular telephone device 1 is folded. The operation unit side body 2 includes, on one side face thereof, side keys 30 to which predetermined functions are assigned, and a cap 31 for an interface where external memory is inserted and removed. The display unit side body 3 includes a sliding key 32 on one side face thereof. The display unit side body 3 includes a camera 33 that captures an image of a subject and a light 34 that irradiates light on the subject. The camera 33 and the light 34 are exposed on a surface of the front case 3b.

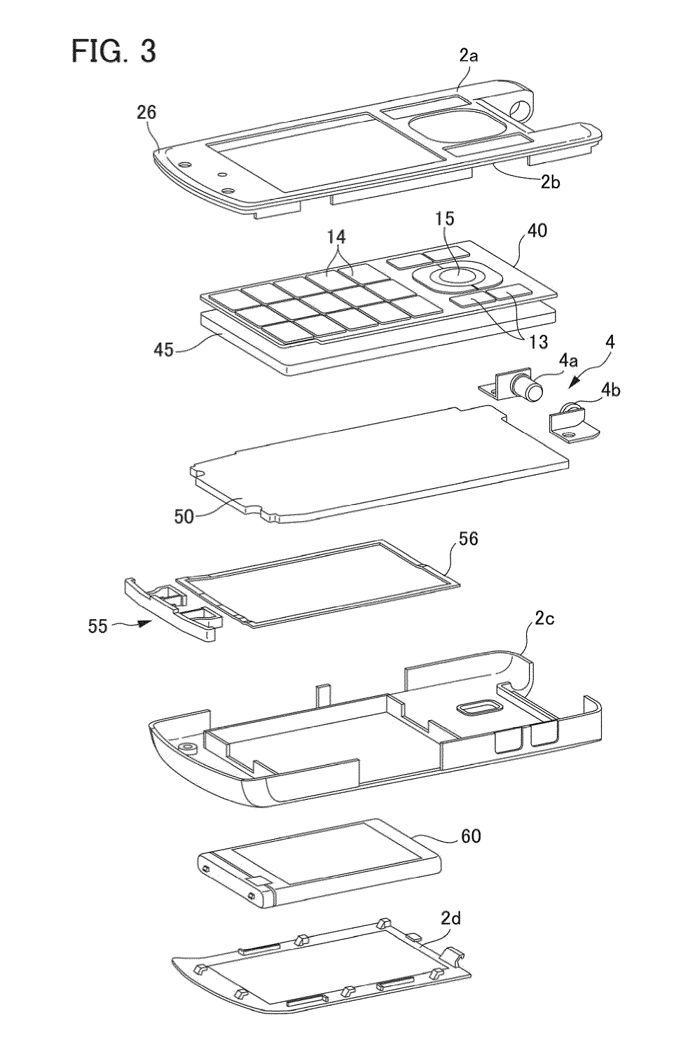

FIG. 3 is an exploded perspective view of members built into the operation unit side body 2. As shown in FIG. 3, the operation unit side body 2 includes: the front panel 2a; the front case 2b (the front panel 2a and the front case 2b are connected in this drawing); a key sheet 40 constituting the aforementioned operation key set 11; a flexible wiring board 45; a printed circuit board 50 (a first circuit board) including various electronic components such as a reference potential pattern layer and an RF (Radio Frequency) module for the cellular telephone device 1; the hinge mechanism 4 (4a, 4b); an antenna element 55; an antenna element 56 for short distance communication; the rear case 2c; and the rear panel 2d protecting a battery 60.

The front case 2b, the key sheet 40, the printed circuit board 50 and the rear case 2c are disposed to be stacked in the operation unit side body 2. The battery 60 is accommodated to be detachable from the outside of the rear panel 2d.

As shown in FIG. 3, the front case 2b and the rear case 2c are disposed such that concave inner surfaces thereof face each other, and are connected such that peripheries thereof superimpose each other. Moreover, the key sheet 40 and the printed circuit board 50 are built in and interposed between the front case 2b and the rear case 2c. In other words, the key sheet 40 is disposed to be stacked on a top face of the printed circuit board 50.

Various electronic components (not shown) are disposed on the printed circuit board 50. The various electronic components form a plurality of circuit blocks by way of predetermined combinations. For example, various circuit blocks including a radio circuit, a power supply circuit, a digital circuit and the like are formed.

A plurality of key holes are formed in the inner surface of the front panel 2a, which is opposed to the display unit 21 of the display unit side body 3 in a state in which the cellular telephone device 1 is folded. Depression faces of the function setting operation keys 13, the character input keys 14 and the selection operation keys 15, which are formed on the key sheet 40, are exposed from the plurality of key holes, respectively. By operating (hereinafter referred to as depressing) the function setting operation keys 13, the character input keys 14 and the selection operation keys 15, which constitute the exposed operation key set 11, an apex of a metal dome (a bowl shape) in the corresponding key switch is depressed. As a result, the metal dome contacts a switch terminal, and the metal dome and the switch terminal are electrically connected.

The hinge mechanism 4 is disposed to one end side of the rear case 2c. The antenna element 55 (antenna) accommodated in a base is disposed to the other end side that is opposite to the one end side of the rear case 2C. Moreover, the antenna element 55 is formed of belt-shaped sheet metal.

The antenna element 55 is an antenna that performs transmission and reception of electromagnetic waves concerning a telephone call or E-mail, and is supplied with electrical power from the printed circuit board 50 via a feed terminal (not shown). The antenna element 55 is connected via the feed terminal to RF modules and the like provided on the printed circuit board 50. Although the position of the antenna element 55 is set at one end of the rear case 2c in the present embodiment, the antenna element 55 may be disposed at any position inside the operation unit side body 2. The antenna element 55 may be disposed at any position inside the display unit side body 3.

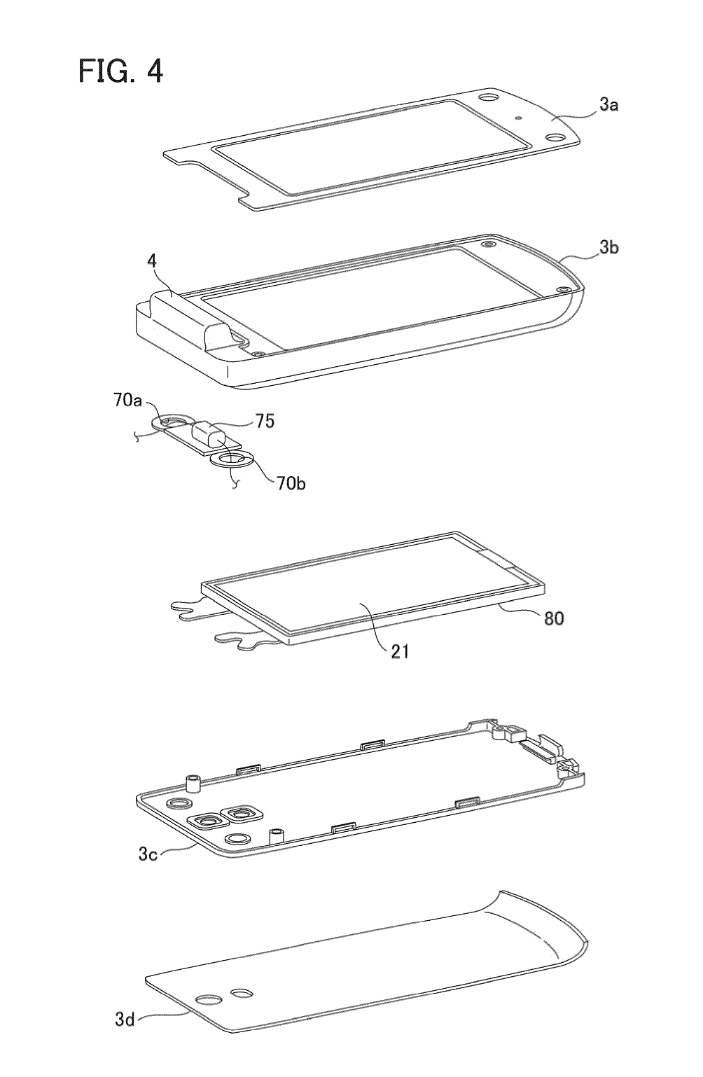

FIG. 4 is an exploded perspective view of members built into the display unit side body 3. As shown in FIG. 4, the display unit side body 3 includes: the front panel 3a; the front case 3b; the hinge mechanism 4; speakers 70a and 70b; a motor 75; the display unit 21; a printed circuit board 80 (second circuit board) to which the display unit 21 is connected; the rear case 3c; and the rear panel 3d. The front panel 3a, the front case 3b, the display unit 21, the printed circuit board 80, the rear case 3c and the rear panel 3d are disposed to be stacked in the display unit side body 3.

As shown in FIG. 4, the front case 3b and the rear case 3c are disposed such that concave inner surfaces thereof face each other, and are connected such that peripheries thereof superimpose each other. The display unit 21 and the printed circuit board 80 are built in between the front case 3b and the rear case 3c. The speakers 70a and 70b and the motor 75 are connected to the printed circuit board 80.

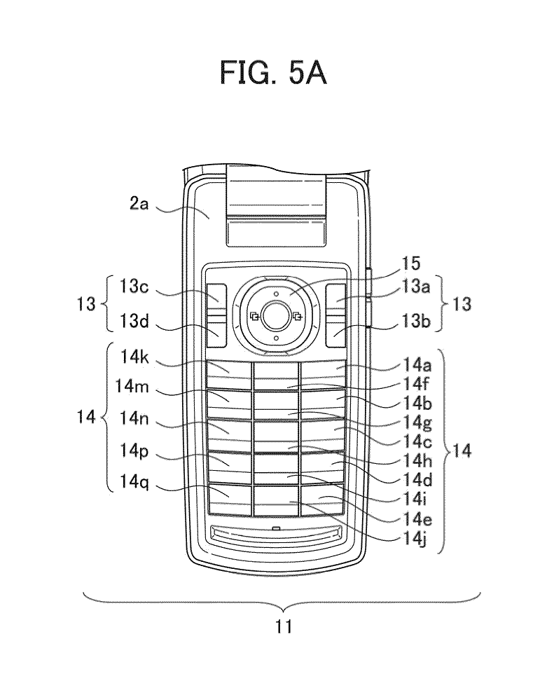

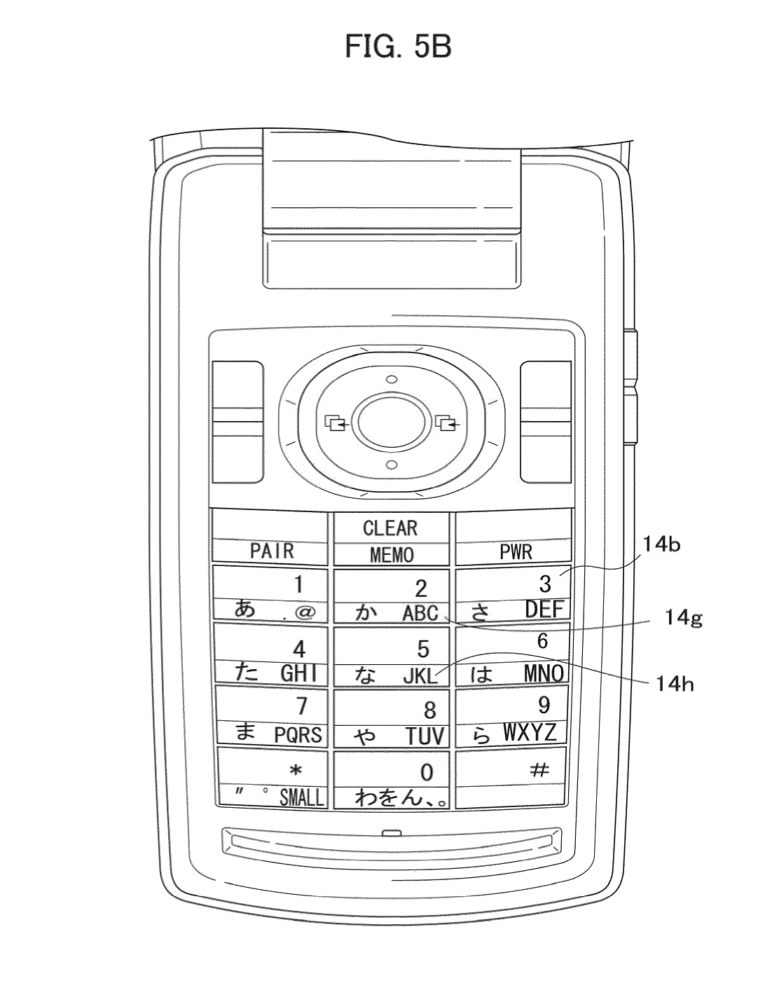

FIG. 5A is a diagram showing an arrangement plan (part 1) of keys provided on the front panel 2a of the operation unit side body 2. FIG. 5B is a diagram showing an enlarged arrangement plan (part 2) of a numeric key portion of the keys provided on the front panel 2a of the operation unit side body 2.

The function setting operation keys 13, the character input keys 14 and the selection operation keys 15, which are formed on the key sheet 40, are exposed from the plurality of key holes formed in the front panel 2a.

The function setting operation keys 13 include a character type selection key 13a, a “WEB” key 13b, a “mail” key 13c and an “address book” key 13d.

The character input keys 14 include a “call-end” key 14a, a “3” key 14b, a “6” key 14c, a “9” key 14d, a “#” key 14e, a “clear” key 14f, a “2” key 14g, a “5” key 14h, an “8” key 14i, a “0” key 14j, an “outgoing call” key 14k, a “1” key 14m, a “4” key 14n, a “7” key 14p, and an “*” key 14q.

By depressing the function setting operation keys 13, the character input keys 14, and the selection operation key 15 that is composed of cursor keys and a selection key as softkeys, which constitute the exposed operation key set 11, a metal dome (bowl shape) in each corresponding key switch is depressed. As a result, the metal dome contacts a switch terminal, and the metal dome and the switch terminal are electrically connected.

A predetermined function is assigned to each key constituting the operation key set 11. Predetermined functions are assigned (key assignment) in accordance with a transformation state such as an opened/closed state and a front/back side state of the operation unit side body 2 and the display unit side body 3, and the type of application that is running. An operation corresponding to a function assigned to each key is executed by the user depressing each key constituting the operation key set 11 of the cellular telephone device 1.

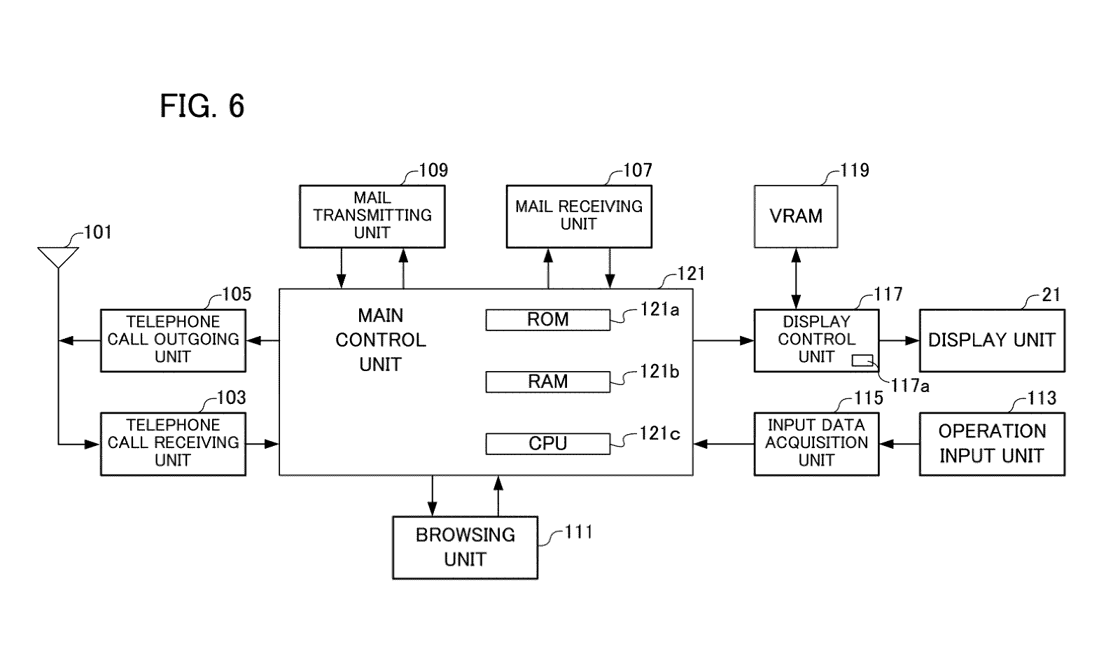

FIG. 6 is a diagram showing an example of a functional block diagram illustrating functions of the cellular telephone device 1. Next, a function of each portion of the cellular telephone device 1 is described with reference to the block diagram shown in FIG. 6. It should be noted that any function among the functions of the cellular telephone device 1 described below may be implemented in collaboration with a CPU as well as programs stored in ROM or RAM.

The cellular telephone device 1 of the present embodiment includes a telephone call receiving unit 103, an outgoing telephone call unit 105, a mail receiving unit 107, a mail transmitting unit 109 and a browsing unit 111. The telephone call receiving unit 103 demodulates radio waves received from an antenna unit 101, and performs reception by phone and reception by mail with other communication terminals via a base station, or downloads a Web page having a predetermined URL from the Internet, based on a predetermined communication method (mobile communication network conforming with, for example, CDMA (Code Division Multiple Access) 2000_{—}1x or the like). The outgoing telephone call unit 105 modulates data and transmits radio waves from the antenna unit 101 in order to perform transmission by phone and transmission by mail with the other communication terminals via the base station or to transmit a predetermined URL to the Internet, based on the aforementioned predetermined communication method. The mail receiving unit 107 has a mailer function to receive mail via the telephone call receiving unit 103 based on the aforementioned predetermined communication method. The mail transmitting unit 109 has a mailer function to transmit mail via the outgoing telephone call unit 105 based on the aforementioned predetermined communication method. The browsing unit 111 transmits a predetermined URL to the Internet via the outgoing telephone call unit 105, and downloads a Web page having a predetermined URL from the Internet via the telephone call receiving unit 103, based on the aforementioned predetermined communication method.

Moreover, the cellular telephone device 1 of the present embodiment includes an operation input unit 113, an input data acquisition unit 115, a display control unit 117 and the display unit 21. The operation input unit 113 detects depression of any key provided to the operation key set 11, and converts it into an electrical signal. The input data acquisition unit 115 inputs an electrical signal from the operation input unit 113, and obtains input data corresponding to each key provided to the operation key set 11. The display control unit 117 functions as a displaying means of the present invention, which writes a character code into VRAM 119, and converts the character code read from the VRAM 119 into character data by way of character generator ROM 117a, thereby generating image data. The display unit 21 displays the image data generated by the display control unit 117. In addition, the cellular telephone device 1 of the present embodiment includes ROM 121a, RAM 121b and a main control unit 121. The ROM 121a stores control programs and function modules for controlling each portion of the cellular telephone device 1. The RAM 121b is RAM for work that serves as a storage area to be temporarily used when executing a control program. The main control unit 121 has a CPU 121c that controls each portion of the cellular telephone device 1 in accordance with a control program read from the ROM 121a.

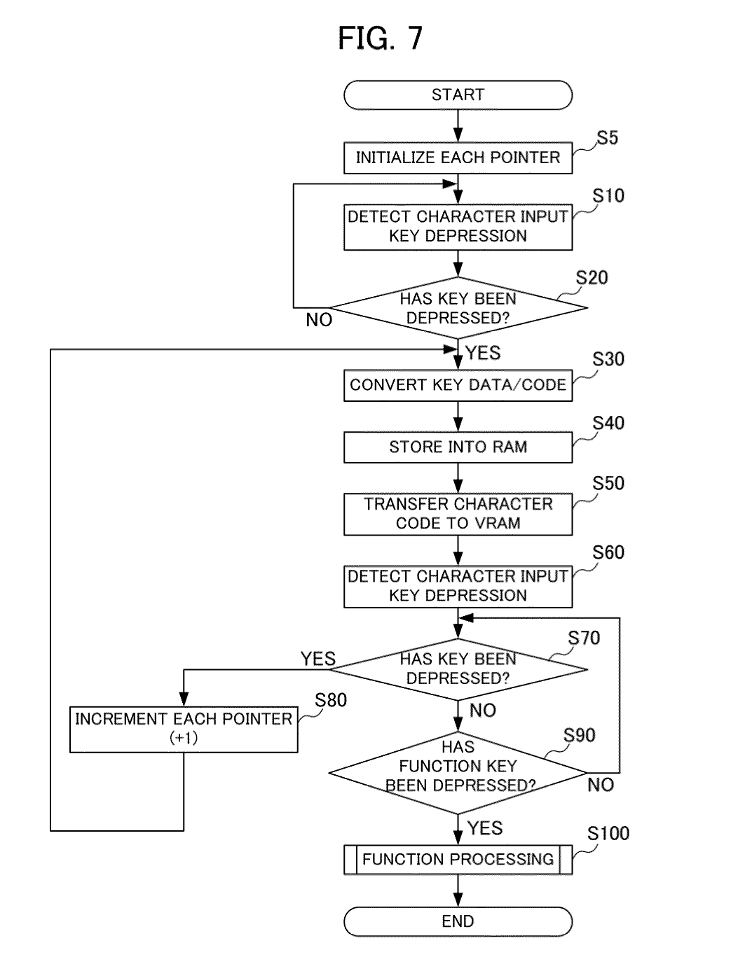

A description is provided hereinafter regarding embodiments of the present invention. It should be noted that, since the configuration of each embodiment is the same (already described above), operations are described with reference to a flowchart of FIG. 7.

FIG. 7 is a flowchart illustrating a first embodiment of the present invention. In a standby state where the cellular telephone device 1 is carried by the user, in other words, in a state of waiting for an input from the user, the cellular telephone device 1 displays a standby screen on the display unit 21. In the first embodiment, operations are described from a state in which a standby screen is displayed to a state in which, when one key is depressed, a plurality of characters (including symbols, graphics and the like in addition to characters such as hiragana characters, katakana characters, alphabetic characters and numeric characters) that are assigned to the key are displayed on a split screen at the same time. It should be noted that, in the present invention, a type of a character assigned to a key is referred to as an input type.

First, in Step S5, the main control unit 121 initializes pointer addresses corresponding to a plurality of storage areas of the RAM 121b and the VRAM 119 to predetermined starting values, respectively, and the processing proceeds to Step S10.

Subsequently, in Step S10, the main control unit 121 detects whether a character input key is depressed. In Step S20, it is determined whether a character input key has been depressed. In a case in which a character input key has been depressed, the processing proceeds to Step S30. In a case in which a character input key has not been depressed, the processing returns to Step S10.

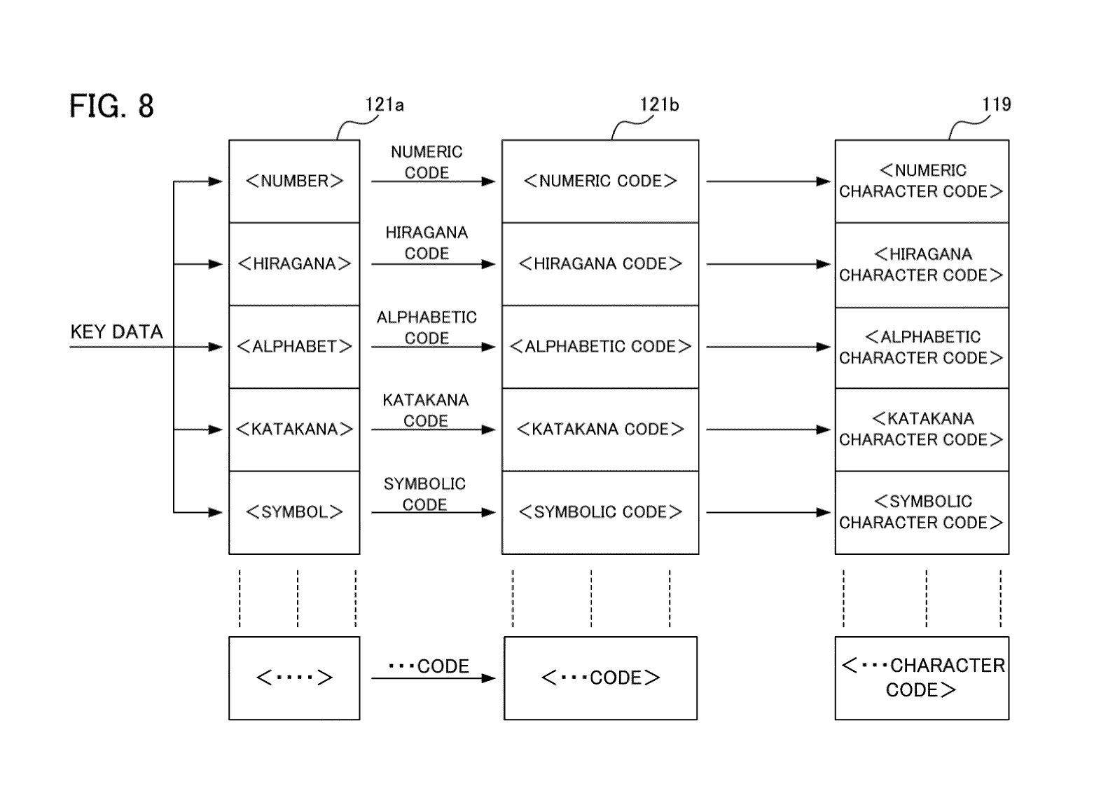

In Step S30, the main control unit 121 receives, via the input data acquisition unit 115, key data of the key depressed by way of the operation input unit 113. Next, the main control unit 121 generates a character code by reading a character code assigned to the key data from the ROM 121a. As shown in FIG. 8, as input information for one piece of input key data, the ROM 121a stores respective character codes for a plurality of character types such as a numeric code, a hiragana code, an alphabetic code, a katakana code, a symbolic code, and other codes. Therefore, the main control unit 121 can read, from the ROM 121a, the respective character codes for different character types, for one piece of input key data that is input. Accordingly, for a plurality of different key data, a plurality of respective character codes corresponding to different character types can be read from the ROM 121a.

Subsequently, in Step S40, as shown in FIG. 8, the character codes for the plurality of character types, which have been read from the ROM 121a, are stored in storage areas of the RAM 121b for the character types, respectively.

In Step S50, the main control unit 121 firstly reads the different character codes stored in the respective storage areas of the RAM 121b. Next, the main control unit 121 outputs the read character codes to the display control unit 117. In this way, the different character codes read from the RAM 121b are stored in the VRAM 119 that is connected to the display control unit 117, thereby completing the transfer. As a result, as shown in FIG. 8, the different character codes are stored in the respective storage areas of the VRAM 119.

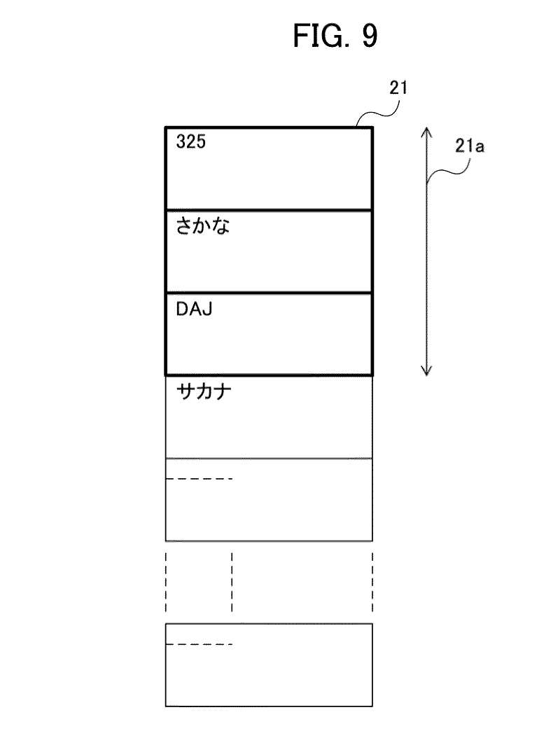

The display control unit 117 reads the character codes from the VRAM 119 at a predetermined display rate. The display control unit 117 reads, from the character generator ROM 117a, character data corresponding to the character codes read from the VRAM 119. The display control unit 117 displays the read character data on the display unit 21. As a result, as shown in FIG. 9, images of the respective different characters are displayed on a display area 21a of the display unit 21. It should be noted that, although the display shown in FIG. 9 is a screen that is displayed immediately after the standby screen, the images of characters may be displayed to be superimposed on the standby screen.

In Step S60, the main control unit 121 detects whether a character input key has been depressed. In Step S70, it is determined whether the character input key has been depressed. In a case in which the character input key has been depressed, the processing proceeds to Step S80. In a case in which the character input key has not been depressed, the processing proceeds to Step S90.

In Step S80, the main control unit 121 increments (+1) the pointer addresses corresponding to the storage areas of the RAM 121b and the VRAM 119, and the processing returns to Step S30.

In Step S90, the main control unit 121 functions as a detecting means of the present invention. The main control unit 121 determines whether a function key for executing a predetermined function has been depressed. In a case in which the function key has been depressed, the processing proceeds to Step S100. In a case in which the function key has not been depressed, the processing returns to Step S70, and the determination processing in Steps S70 and S90 is repeated until a character input key or a function key is input.

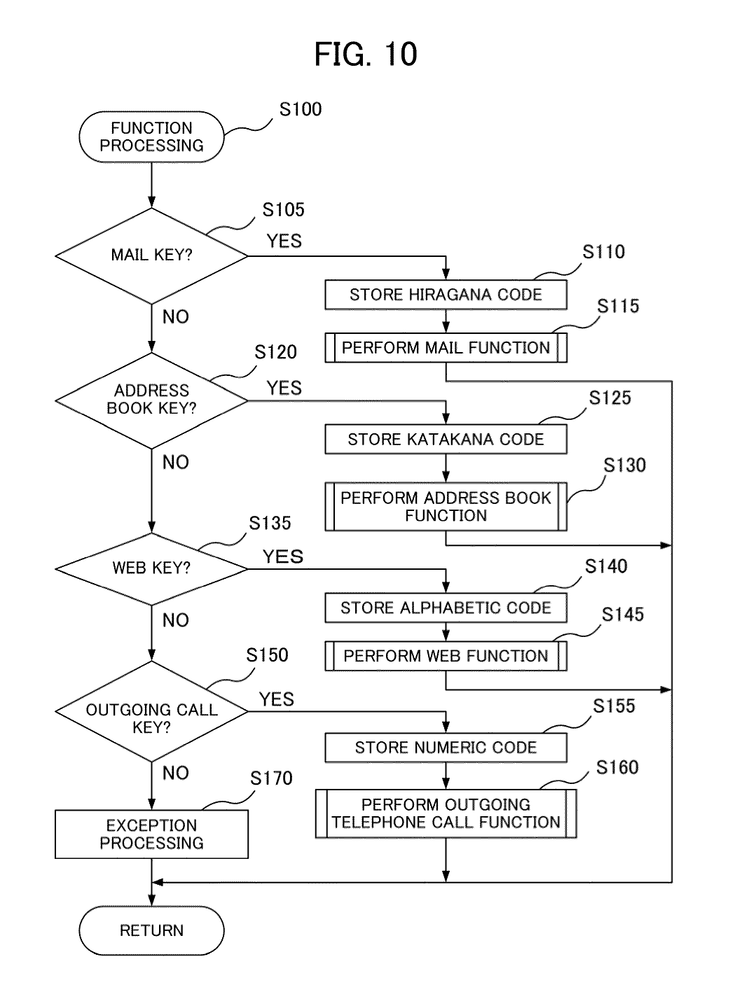

In Step S90, the main control unit 121 functions as a first executing means of the present invention. In a case in which the main control unit 121 detects that a function key for executing a predetermined function has been depressed, the processing proceeds to Step S100. Step S100 is a subroutine for executing function processing, and a flowchart of this subroutine is shown in FIG. 10.

Now with reference to FIG. 10, in Step S105, the main control unit 121 determines whether the “mail” key 13d as a function key has been depressed. In a case in which it is determined that the “mail” key 13d has been depressed based on key data that is input from the input data acquisition unit 115, the processing proceeds to Step S110. In Step S110, a character code of one character type that is displayed on the screen corresponding to this function key is selected and read from a storage area of the RAM 121b, and is stored in a work area of the RAM 121b. In a case in which the “mail” key 13d has been depressed, the main control unit 121 selects a storage area of the “hiragana code” provided in the RAM 121b, reads a character code from this storage area, and stores it in a work area of the RAM 121b.

Subsequently, in Step S115, in order to execute a mail function based on the character code of this selected character type, the main control unit 121 reads and executes a mail function module stored in the ROM 121a. In this case, an input operation of a mail text using a hiragana input can be continued.

On the other hand, in a case in which the “mail” key 13d has not been depressed in Step S105, the processing proceeds to Step S120. In Step S120, the main control unit 121 determines whether the “address book” key 13c as a function key has been depressed. In a case in which the main control unit 121 determines that the “address book” key 13c has been depressed based on key data that is input from the input data acquisition unit 115, the processing proceeds to Step S125. In Step S125, the main control unit 121 selects and reads, from a storage area of the RAM 121b, a character code of one character type that is displayed on the screen corresponding to this function key, and stores it in a work area of the RAM 121b. In a case in which the “address book” key 13c has been depressed, the main control unit 121 selects a storage area of the “katakana code” provided in the RAM 121b, reads a character code from this storage area, and stores it in a work area of the RAM 121b.

Subsequently, in Step S130, in order to execute an address book function based on the character code of this selected character type, the main control unit 121 executes an address book function module. In this case, the address book can be searched based on an input operation of a name by way of a katakana input.

In a case in which the “address book” key 13c has not been depressed in the aforementioned Step S120, the processing proceeds to Step S135, and the main control unit 121 determines whether the “Web” key 13b as a function key has been depressed. In a case in which the main control unit 121 determines that the “Web” key 13b has been depressed based on key data that is input from the input data acquisition unit 115, the processing proceeds to Step S140. In Step S140, the main control unit 121 selects and reads, from a storage area of the RAM 121b, a character code of one character type that is displayed on the screen corresponding to this function key, and stores it in a work area of the RAM 121b. In a case in which the “Web” key 13b has been depressed, the main control unit 121 selects a storage area of the “alphabetic code” provided in the RAM 121b, reads a character code from this storage area, and stores it in a work area of the RAM 121b.

Subsequently, in Step S145, in order to execute a Web function based on the character code of this selected character type, the main control unit 121 executes a Web function module and activates the browsing unit 111. In this case, the browsing unit 111 accesses a URL address by way of an alphabetic character input that is stored in a storage area of the “alphabetic code”, and the user can browse a Web site.

In a case in which the “Web” key 13b was not depressed in Step S135, the processing proceeds to Step S150, and the main control unit 121 determines whether the “outgoing call” key 14k as a function key has been depressed. In a case in which it is determined that the “outgoing call” key 14k has been depressed based on key data that is input from the input data acquisition unit 115, the processing proceeds to Step S155. In Step S155, the main control unit 121 selects and reads, from a storage area of the RAM 121b, a character code of one character type that is displayed on the screen corresponding to this function key, and stores it in a work area of the RAM 121b. In a case in which the “outgoing call” key 14k has been depressed, the main control unit 121 selects a storage area of the “numeric code” provided in the RAM 121b, reads a character code from this storage area, and stores it in a work area of the RAM 121b.

Subsequently, in Step S160, in order to execute an outgoing call function based on the character code of this selected character type, the main control unit 121 executes a telephone function module and activates the outgoing telephone call unit 105. In this case, the user can make a phone call to a telephone of another party based on a telephone number corresponding to numeric characters of the character codes stored in the storage area of the “numeric code”.

In a case in which the “outgoing call” key 14k was not depressed in the aforementioned Step S150, the processing proceeds to Step S170, and the main control unit 121 performs exception processing due to having accepted a function key other than the aforementioned function keys, and returns to the main routine to complete the processing.

As described above, in the first embodiment, in a case in which the cellular telephone device 1 detects depression of a character key from the standby screen, a plurality of characters (including symbols, graphics and the like in addition to characters) that are assigned to the key are displayed on a split screen at the same time. Therefore, efficient input can be easily performed. Furthermore, in a case in which a function key has been depressed, it is possible to obtain an optimal character code for the function key among the character codes that have been input in advance, and therefore a function operation corresponding to the function can be easily performed.

It should be noted that, in the first embodiment, it is preferable to detect whether a depression period of time of a function key is longer or shorter than a predetermined reference period of time, and in a case in which the depression period of time of the function key is longer than the predetermined reference period of time, a function is executed based on a character code of a particular character type, and in a case in which the depression period of time thereof is shorter than the predetermined reference period of time, a function is executed based on a character code of a character type that is different from this particular character type. In this case, the main control unit 121 functions as a first changing means for changing a function based on a depression period of time of a function key.

Although simplification of a function invocation for the Web function has been described in the first embodiment, the present invention is not limited to such a case, and a configuration may be employed to detect whether a depression period of time of the Web function key is longer (long depression) or shorter (short depression) than a predetermined reference period of time. In addition, a configuration may be employed such that a URL address is designated by using an “alphabetic” character code to connect to a Web site in a case of a long depression, while a configuration may be employed such that an “alphabetic” character code is used to connect to a search site to perform search processing in a case of a short depression.

Although simplification of a function invocation for the mail function has been described in the first embodiment, the present invention is not limited to such a case, and a configuration may be employed to detect whether a depression period of time of the mail function key is longer (long depression) or shorter (short depression) than a predetermined reference period of time. In addition, a configuration may be employed such that an address is designated by using an “alphabetic” character code to activate the mail function in a case of a long depression, while a configuration may be employed such that a “hiragana” character code is used to activate a text creating screen of the mail function in a case of a short depression.

Although simplification of a function invocation for the address book function has been described in the first embodiment, the present invention is not limited to such a case, and a configuration may be employed to detect whether a depression period of time of the address book function key is longer (long depression) or shorter (short depression) than a predetermined reference period of time. In addition, a configuration may be employed such that a name is designated by using a “hiragana” character code to activate the address book function in a case of a long depression, while a configuration may be employed such that a “numeric” character code is used to activate the address book function in a case of a short depression. Furthermore, in the present invention, the combinations of each function key and a selected character code are not limited to the cases shown in the first embodiment, and they may be other appropriate combinations.

### Second Embodiment

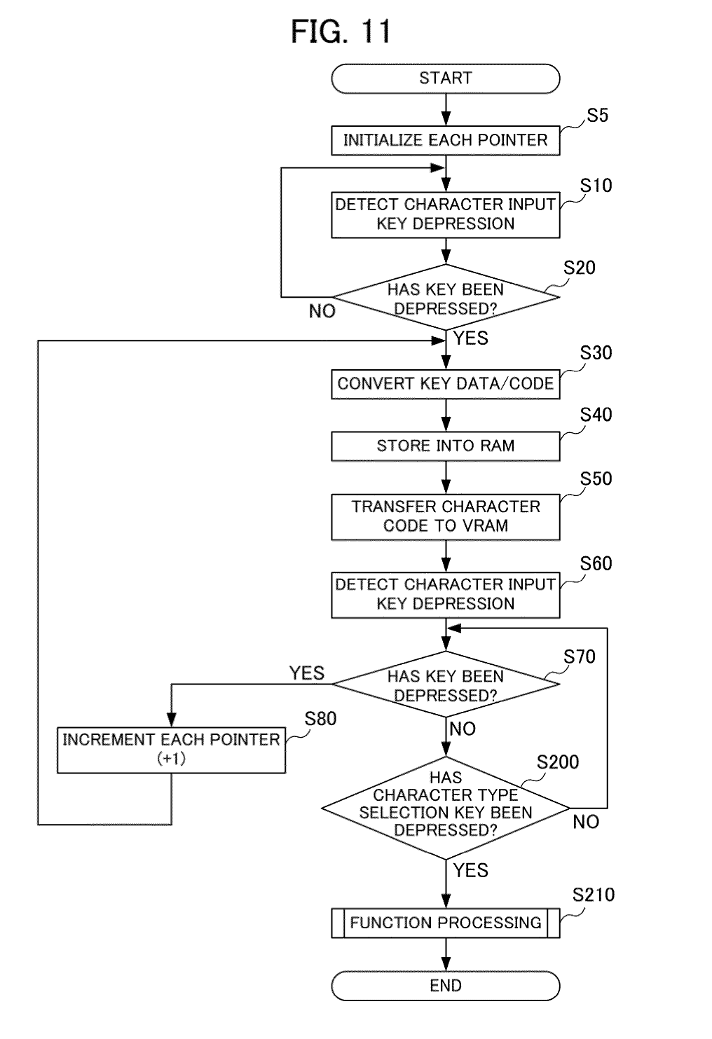

FIG. 11 is a flowchart illustrating a second embodiment of the present invention. In the second embodiment, in accordance with depression detection of a character type selection key, function processing based on the selected character type is executed. It should be noted that, since the basic steps are common to the flowchart shown in FIG. 11 and the flowchart shown in FIG. 7, different reference numerals are assigned only to steps that are different therefrom.

In Step S200 shown in FIG. 11, the main control unit 121 determines whether a character type selection key 13a for selecting a character type has been depressed. In other words, the character type selection key 13a is provided with: a “hiragana” mode for inputting and converting hiragana characters into Chinese characters; a “katakana” mode for inputting katakana characters; an “alphabetic” mode for inputting alphabetic characters; and a “numeric” mode for inputting numeric characters. In addition, a character type output function can be provided, in which the mode is switched, for example, from “hiragana” to “katakana” to “alphabetic” to “numeric” and to “hiragana” in accordance with the number of times the character type selection key 13a is depressed, and a currently selected mode state is set as a character type and is written into a work area of the RAM 121b to be output. Furthermore, in a case in which there is no input from the character type selection key 13a for a predetermined period of time (for example, two seconds) since there was an input from the character type selection key 13a, it is assumed that a character type in the latest selection has been decided. Then, in a case in which the character type selection key 13a has been depressed, the processing proceeds to Step S210. In a case in which the character type selection key 13a has not been depressed, the processing returns to Step S70, and the determination processing in Steps S70 and S200 is repeated until a character input key or the character type selection key 13a is input.

In a case in which it is detected that the character type selection key 13a for selecting a character type has been depressed, the main control unit 121 executes a subroutine for executing function processing in Step S210.

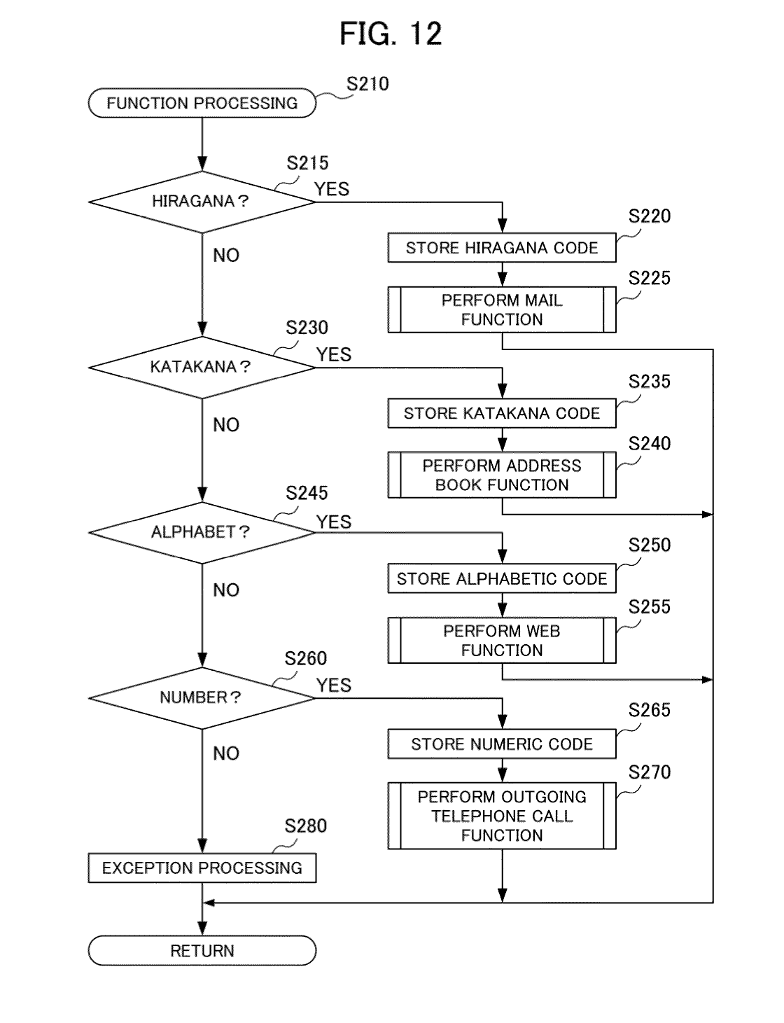

Now with reference to FIG. 12, in Step S215, the main control unit 121 determines whether a “hiragana” character has been selected as a character type, by way of depression of the character type selection key 13a. In a case in which the main control unit 121 determines that “hiragana” has been selected based on “character type” data read from the work area of the RAM 121b, the processing proceeds to Step S220. In Step S220, the main control unit 121 selects and reads, from a storage area of the RAM 121b, a character code of a character type that is displayed on the screen corresponding to this character type, and stores it in a work area of the RAM 121b. In a case in which “hiragana” has been selected, the main control unit 121 selects a storage area of the “hiragana code” provided in the RAM 121b, reads a character code from this storage area, and stores it in a work area of the RAM 121b.

In Step S225, the main control unit 121 functions as a second executing means of the present invention. In order to execute a mail function based on the character code of this selected character type, the main control unit 121 executes a mail function module. In this case, an input operation of a mail text using a hiragana input can be continued.

On the other hand, in the aforementioned Step S215, in a case in which a “hiragana” character is not selected as a character type, the processing proceeds to Step S230, and the main control unit 121 determines whether a “katakana” character is selected as a character type. In a case in which the main control unit 121 determines that “katakana” has been selected based on “character type” data read from the work area of the RAM 121b, the processing proceeds to Step S235. In Step S235, a character code of a character type, which is displayed on the screen corresponding to this character type, is selected and read from a storage area of the RAM 121b, and stored in a work area of the RAM 121b. In a case in which “katakana” has been selected, the main control unit 121 selects a storage area of the “katakana code” provided in the RAM 121b, reads a character code from this storage area, and stores it in a work area of the RAM 121b.

Subsequently, in Step S240, in order to execute the address book function based on the character code of this selected character type, the main control unit 121 executes the address book function module. In this case, the address book can be searched based on an input operation of a name by way of a katakana input.

In a case in which a “katakana” character has not been selected as a character type in the aforementioned Step S230, the processing proceeds to Step S245. The main control unit 121 determines whether an “alphabetic” character is selected as a character type, by way of depression of the character type selection key 13a. In a case in which the main control unit 121 determines that an “alphabetic character” has been selected based on “character type” data read from the work area of the RAM 121b, the processing proceeds to Step S250. In Step S250, the main control unit 121 selects and reads, from a storage area of the RAM 121b, a character code of a character type that is displayed on the screen corresponding to this character type, and stores it in a work area of the RAM 121b. In a case in which an “alphabetic character” has been selected, the main control unit 121 selects a storage area of the “alphabetic code” provided in the RAM 121b, reads a character code from this storage area, and stores it in a work area of the RAM 121b.

Subsequently, in Step S255, in order to execute the Web function based on the character code of this selected character type, the main control unit 121 executes the Web function module and activates the browsing unit 111. In this case, a Web site can be browsed based on an input operation of a URL by way of an alphabetic input.

In a case in which an “alphabetic” character is not selected as a character type in the aforementioned Step S245, the processing proceeds to Step S260. The main control unit 121 determines whether a “numeric” character is selected as a character type, by way of depression of the character type selection key 13a. In a case in which the main control unit 121 determines that a “numeric character” has been selected based on “character type” data read from the work area of the RAM 121b, the processing proceeds to Step S265. In Step S265, the main control unit 121 selects and reads, from a storage area of the RAM 121b, a character code of a character type that is displayed on the screen corresponding to this character type, and stores it in a work area of the RAM 121b. In a case in which a “numeric character” has been selected, the main control unit 121 selects a storage area of the “numeric code” provided in the RAM 121b, reads a character code from this storage area, and stores it in a work area of the RAM 121b.

Subsequently, in Step S270, in order to execute the outgoing call function based on the character code of this selected character type, the main control unit 121 executes the telephone function module and activates the outgoing telephone call unit 105. In this case, a phone call can be made to a telephone of another party based on a telephone number corresponding to numeric characters of the character codes stored in the storage area of the “numeric code”.

In a case in which a “numeric character” has not been selected in the aforementioned Step S260, the processing proceeds to Step S280, and the main control unit 121 performs exception processing due to having accepted a character type other than the aforementioned character types, and returns to the main routine to complete the processing.

As described above, in the second embodiment, in a case in which the cellular telephone device 1 detects depression of a character key from the standby screen, a plurality of characters (including symbols, graphics and the like in addition to characters) that are assigned to the key are displayed on a split screen at the same time. Therefore, efficient input can be easily performed. Furthermore, in a case in which a character type key has been depressed, it is possible to obtain a character code corresponding to the character type key among the character codes that have been input in advance, and therefore a function operation corresponding to the character type can be easily performed. It should be noted that, in the present invention, the combinations of a selected character type and an executed function are not limited to the cases shown in the second embodiment, and they may be other appropriate combinations.

### Third Embodiment

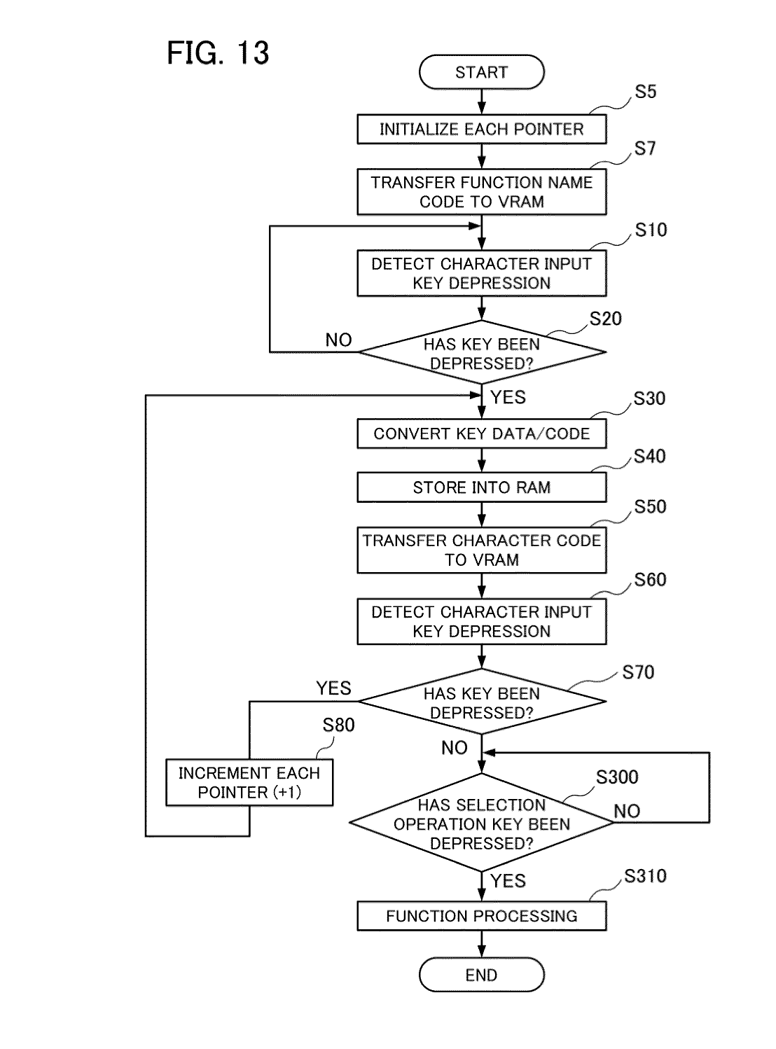

FIG. 13 is a flowchart illustrating a third embodiment of the present invention. In the third embodiment, each function name is displayed in advance on a small area provided to a screen for each character type, and an active character type and a function are selected at the same time in accordance with a cursor movement of the selection operation key 15, thereby executing function processing. It should be noted that, since the basic steps are common to the flowchart shown in FIG. 13 and the flowchart shown in FIG. 7, different reference numerals are assigned only to steps that are different therefrom.

In Step S7 shown in FIG. 13, the main control unit 121 reads character codes indicating different function names from the ROM 121a. Subsequently, by outputting this to the display control unit 117, the different character codes indicating the function names are stored in the VRAM 119 that is connected to the display control unit 117, thereby completing the transfer. As a result, the different character codes are stored in the respective storage areas of the VRAM 119.

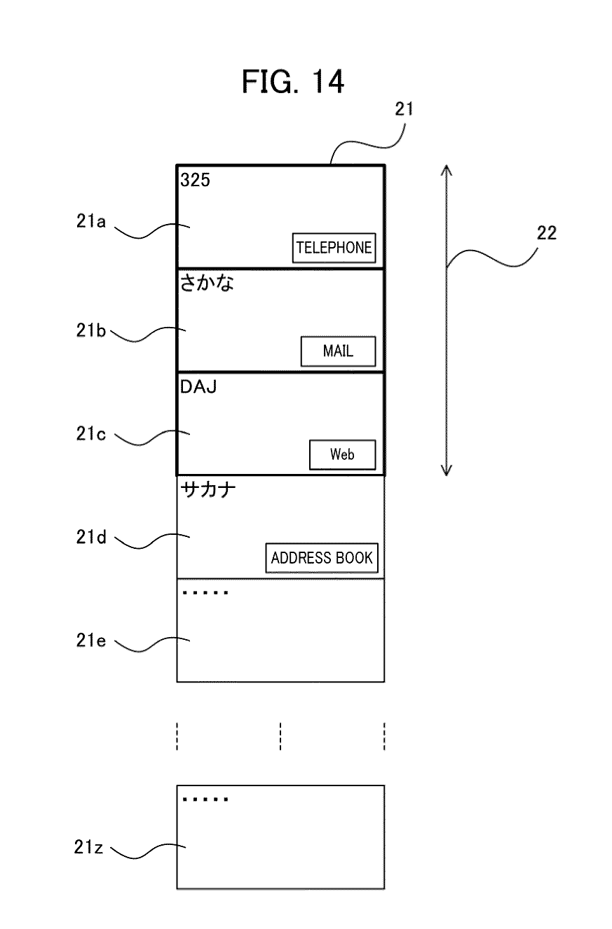

Here, the display control unit 117 reads the character codes from the VRAM 119 at a predetermined display rate, and reads, from the character generator ROM 117a, character data corresponding to the character codes read from the VRAM 119. The display control unit 117 displays the read character data on the display unit 21. As a result, as shown in FIG. 14, a character and a function for each character type are displayed respectively on a display area 21a of the display unit 21.

In Step S300 shown in FIG. 13, the main control unit 121 functions as a third executing means of the present invention, and determines whether the selection operation key 15 for selecting a character type and a function corresponding to this character type has been depressed. In a case in which the selection operation key 15 has been depressed, the processing proceeds to Step S310. In a case in which the selection operation key 15 has not been depressed, the processing returns to Step S70, and the determination processing in Steps S70 and S300 is repeated until a character input key or the selection operation key 15 is input.

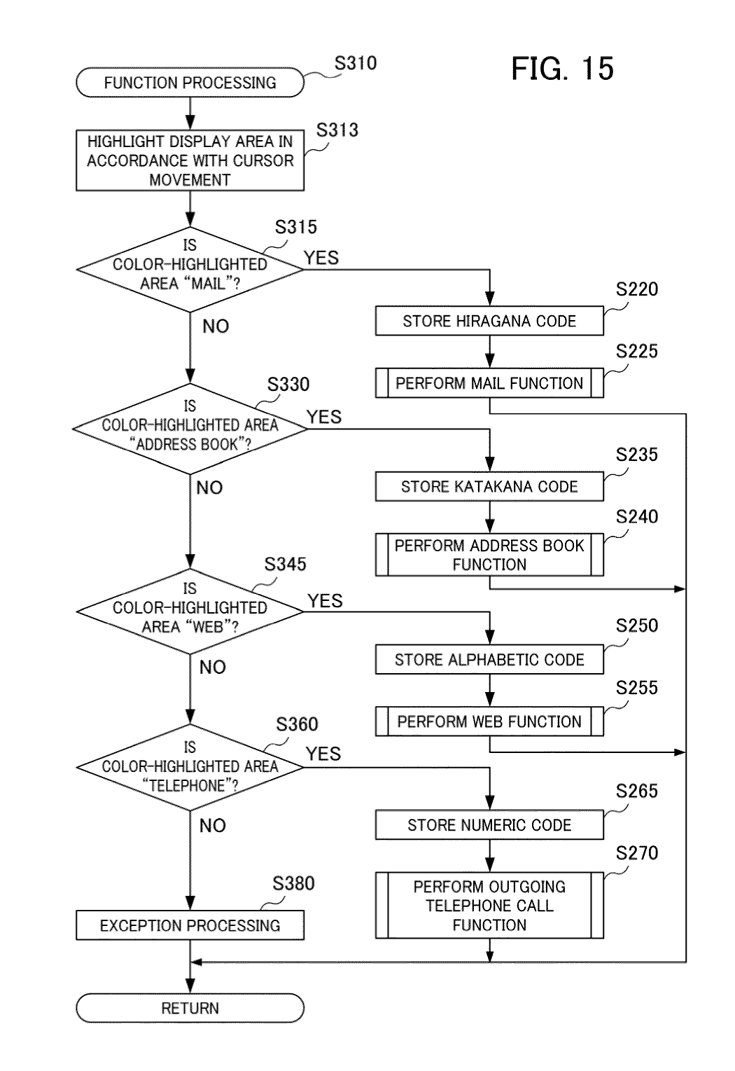

In a case in which it is detected that the selection operation key 15 for selecting a character type and a function corresponding to this character type has been depressed, a subroutine for executing function processing shown in FIG. 15 is executed in Step S310.

Now with reference to FIG. 15, in Step S313, the main control unit 121 highlights a color of a display area in accordance with a cursor movement. In other words, in a case in which a cursor of the selection operation key 15 has been depressed, the main control unit 121 highlights a color of one of the display areas of the VRAM 119 managed by the display control unit 117, based on key data that is input from the input data acquisition unit 115. As a result, as shown in FIG. 14, for example, a display area 21b, on which “ [symbol] ” is displayed with “hiragana” characters and the corresponding function is displayed as “mail”, is displayed by highlighting the color thereof as compared with the other areas. Moreover, in FIG. 14, although the display areas 21a, 21b and 21c in a range indicated by an arrow 22 are displayed as being active on the display unit 21, the display areas and the highlighted areas can be moved in a longitudinal direction in accordance with a travel distance of the cursor. In addition, the screen of the display areas may be scrolled in accordance with a travel distance of the cursor, and for example, display areas 21d, 21e . . . and 21z may be sequentially displayed in substitution for the display areas 21a, 21b and 21c. It should be noted that, although 26 display areas from the display area 21a to the display area 21z are illustrated in the example shown in FIG. 14, the number of the display areas in the present invention is not limited to 26, and it may be an arbitrary number.

Subsequently, in Step S315, the main control unit 121 determines whether “mail” is selected as a color-highlighted area, by way of depression of the cursor of the selection operation key 15. In other words, in a case in which the main control unit 121 caused a character code indicating “mail” to be read from the color-highlighted area of the VRAM 119, the processing proceeds to Step S220, and the processing of the aforementioned Steps S220 and S225 is executed, thereby executing the mail function module. In this case, an input operation of a mail text using a hiragana input can be continued.

Subsequently, in Step S330, the main control unit 121 determines whether “address book” has been selected as a color-highlighted area, by way of depression of the cursor of the selection operation key 15. In other words, in a case in which the main control unit 121 caused a character code indicating “address book” to be read from the color-highlighted area of the VRAM 119, the processing proceeds to Step S235. By executing the processing of the aforementioned Steps S235 and S240, the main control unit 121 executes the address book function module. In this case, the address book can be searched based on an input operation of a name by way of a katakana input.

Subsequently, in Step S345, the main control unit 121 determines whether “Web” has been selected as a color-highlighted area, by way of depression of the cursor of the selection operation key 15. In other words, in a case in which the main control unit 121 caused a character code indicating “Web” to be read from the color-highlighted area of the VRAM 119, the processing proceeds to Step S250. By executing the processing of the aforementioned Steps S250 and S255, the main control unit 121 executes the Web function module and activates the browsing unit 111. In this case, a Web site can be browsed based on an input operation of a URL by way of an alphabetic input.

Subsequently, in Step S360, the main control unit 121 determines whether “telephone” has been selected as a color-highlighted area, by way of depression of the cursor of the selection operation key 15. In other words, in a case in which the main control unit 121 caused a character code indicating “telephone” to be read from the color-highlighted area of the VRAM 119, the processing proceeds to Step S265. By executing the processing of the aforementioned Steps S265 and S270, the main control unit 121 executes the telephone function module and activates the outgoing telephone call unit 105. In this case, a phone call can be made to a telephone of another party based on a telephone number corresponding to numeric characters of the character codes stored in the storage area of the “numeric code”.

In the aforementioned Step S360, in a case in which a color-highlighted area is not selected due to depression of the cursor of selection operation key 15, the processing proceeds to Step S380, and the main control unit 121 performs exception processing due to having accepted a character type other than the aforementioned character types, and returns to the main routine to complete the processing.

As described above, in the third embodiment, in a case in which the cellular telephone device 1 detects depression of a character key from the standby screen, a plurality of characters (including symbols, graphics and the like in addition to characters) that are assigned to the key are displayed on a split screen at the same time, and therefore efficient input can be easily performed. Furthermore, in a case in which the cursor of the selection operation key 15 has been depressed, it is possible to obtain a character code corresponding to the color-highlighted area among the character codes that have been input in advance. Therefore, a function operation corresponding to the character type can be easily performed. It should be noted that, in the present invention, the relationship between a function and a selected character type is not limited to the examples shown in the third embodiment, and they may be other appropriate combinations.

### Fourth Embodiment

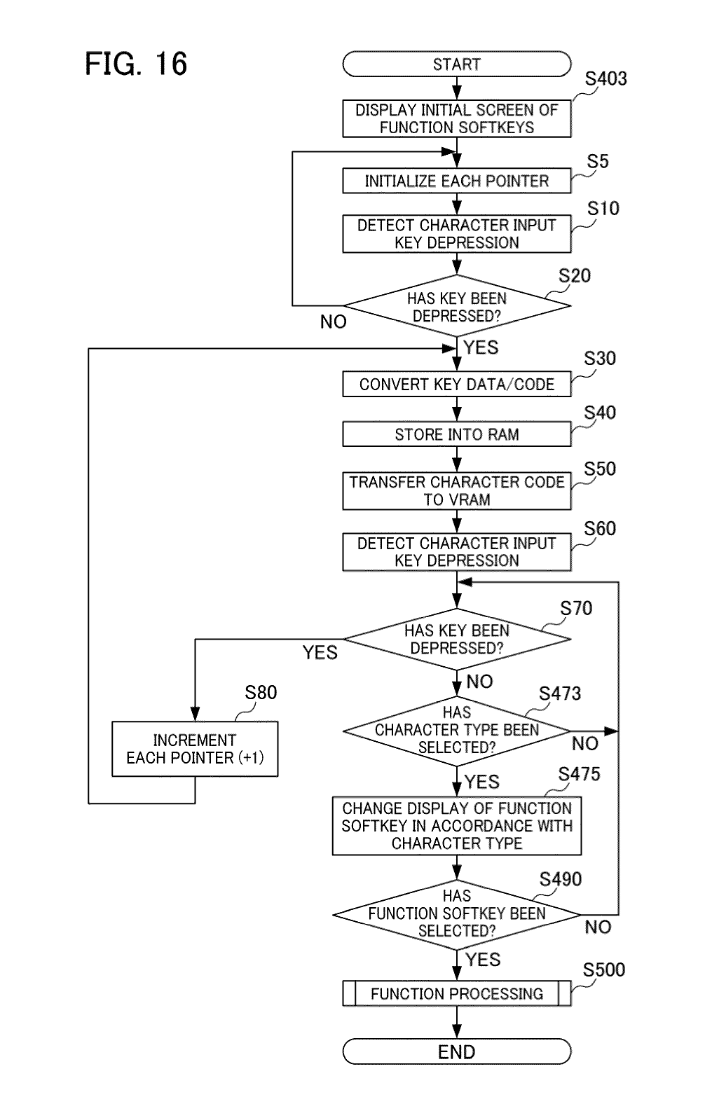

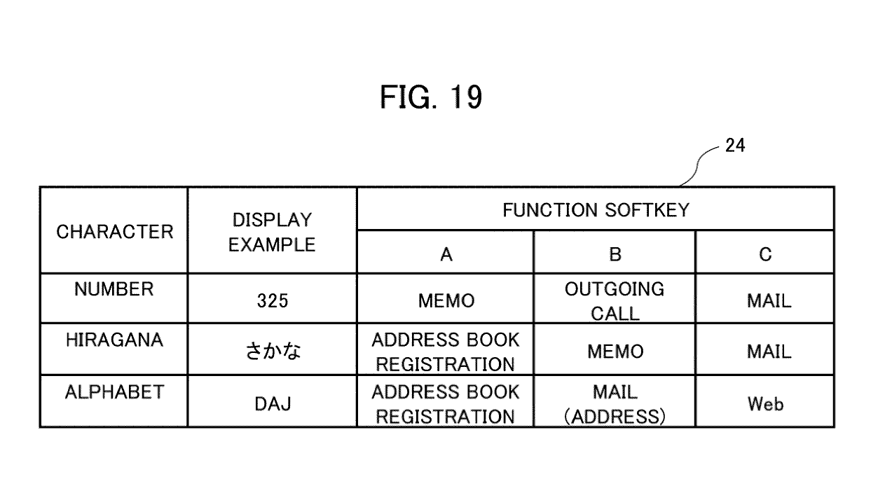

FIG. 16 is a flowchart illustrating a fourth embodiment of the present invention. In the fourth embodiment, the main control unit 121 displays a plurality of identical or different function softkeys in accordance with one character type selected from among a plurality of character types displayed on the screen. Next, the main control unit 121 executes desired function processing based on a selected function softkey. It should be noted that, since the basic steps are common to the flowchart shown in FIG. 16 and the flowchart shown in FIG. 7, different reference numerals are assigned only to steps that are different therefrom. Moreover, FIG. 19 is a diagram showing contents of a function softkey table referred by the main control unit 121.

Here, a function softkey table 24 shown in FIG. 19 is described. The function softkey table 24 stores, in the ROM 121a, a plurality of different character types and character codes of function names that are distinguished and assigned as (A), (B) and (C) in association with respective display positions of, for example, three kinds of functions corresponding to the plurality of character types. When the main control unit 121 designates a character type, the function softkey table 24 serves to add a display position to a character code, which indicates a function name of a function softkey corresponding to the designated character type, and to return them to the main control unit 121.

In Step S403 shown in FIG. 16, the main control unit 121 displays an initial screen of the function softkeys. In other words, as shown in FIG. 19, the main control unit 121 reads character codes indicating different function names regarding, for example, a “numeric” character type, from the function softkey table 24 stored in the ROM 121a. Next, the read character codes are output to the display control unit 117. In this way, the different character codes indicating the function names are stored in the VRAM 119 that is connected to the display control unit 117, thereby completing the transfer. As a result, the different character codes are stored in the respective storage areas of the VRAM 119.

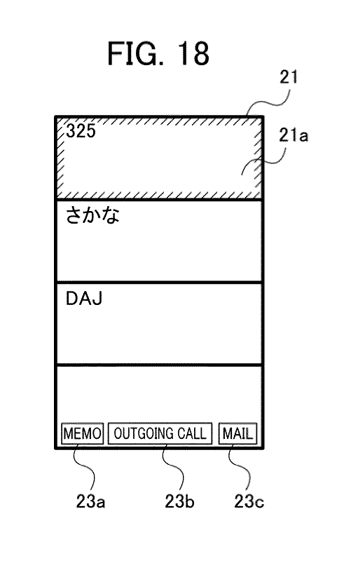

Here, the display control unit 117 reads the character codes from the VRAM 119 at a predetermined display rate, and reads, from the character generator ROM 117a, character data corresponding to the character codes read from the VRAM 119. The display control unit 117 displays the read character data on the display unit 21. As a result, as shown in FIG. 18, in the lowermost part of the display area 21a of the display unit 21, a function softkey “memo” 23a, a function softkey “outgoing call” 23b, and a function softkey “mail” 23c are displayed in the lowermost part of the screen of the display unit 21, as an initial screen of the function softkeys corresponding to the “numeric” character type.

In Step S473 shown in FIG. 16, in a case in which the cursor of the selection operation key 15, which functions as a selecting means of the present invention, has been depressed in a longitudinal direction, the main control unit 121 determines whether a character type selection has been made, based on key data that is input from the input data acquisition unit 115. Here, in a case in which a character type selection has been made, the selected “character type” data is stored in a work area of the RAM 121b, and thereafter the processing proceeds to Step S475. On the other hand, in a case in which a character type selection has not been made, the processing returns to Step S70.

It should be noted that, in the aforementioned Step S473, in a case in which the cursor is moved in the longitudinal direction in order to select a character type displayed on the screen 21, the main control unit 121 highlights a color of the display area in accordance with the cursor movement. In other words, in a case in which the cursor of the selection operation key 15 was depressed, the main control unit 121 highlights a color of one of the display areas of the VRAM 119 managed by the display control unit 117, based on key data that is input from the input data acquisition unit 115. As a result, as shown in FIG. 18, for example, “325” is displayed with “numeric” characters, and the display area 21a that displays “325” is displayed by highlighting the color thereof as compared with the other areas. The display area and the highlighted area that are being displayed can be moved in the longitudinal direction in accordance with a travel distance of the cursor. Moreover, regarding the function softkeys 23a, 23b and 23c shown in FIG. 18, a highlighted area of a function softkey that becomes active can be moved in the lateral direction in accordance with a travel distance of the cursor.

In Step S475, the main control unit 121 functions as a second changing means of the present invention, and changes the display of a function softkey in accordance with a color-highlighted and selected character type. In other words, the main control unit 121 reads the character type data selected in Step S473 from the work area of the RAM 121b, and changes the display contents of the function softkeys in accordance with this character type.

Here, based on the selected character type, the main control unit 121 reads character codes indicating different function names and display positions thereof from the function softkey table 24 (shown in FIG. 19) stored in the ROM 121a, and outputs this to the display control unit 117. In this way, the main control unit 121 stores the different character codes indicating the function names in the VRAM 119, which is connected to the display control unit 117, thereby completing the transfer. As a result, the different character codes are stored in the respective storage areas of the VRAM 119. Subsequently, in the display area 21a of the display unit 21, a function softkey “address book” 23a, a function softkey “memo” 23b, and a function softkey “mail” 23c are displayed in the lowermost part of the screen 21, as a screen of the function softkeys corresponding to the “hiragana” character type.

Subsequently, in Step S490, the main control unit 121 determines whether a function softkey on the screen has been selected. In other words, the main control unit 121 determines whether a lateral-direction cursor of the selection operation key 15 has been depressed and the selection key has been depressed in order to select a function corresponding to a color-highlighted character type. In a case in which the selection key of the selection operation key 15 was depressed, the processing proceeds to Step S500. In a case in which the selection operation key 15 has not been depressed, the processing returns to Step S70, and the determination processing in Steps S475 and S490 is repeated until the selection key of the selection operation key 15 is input.

In a case in which the main control unit 121 detects that a function softkey has been selected in accordance with depression of the selection operation key 15, the main control unit 121 highlights the color of the display area of the selected function key in accordance with a cursor movement in Step S500. In other words, in a case in which the cursor of the selection operation key 15 has been depressed, the main control unit 121 highlights a color of one of the function softkey display areas 23a, 23b and 23c of the VRAM 119 managed by the display control unit 117, based on key data that is input from the input data acquisition unit 115. Subsequently, in Step S500, the main control unit 121 executes a subroutine for executing function processing.

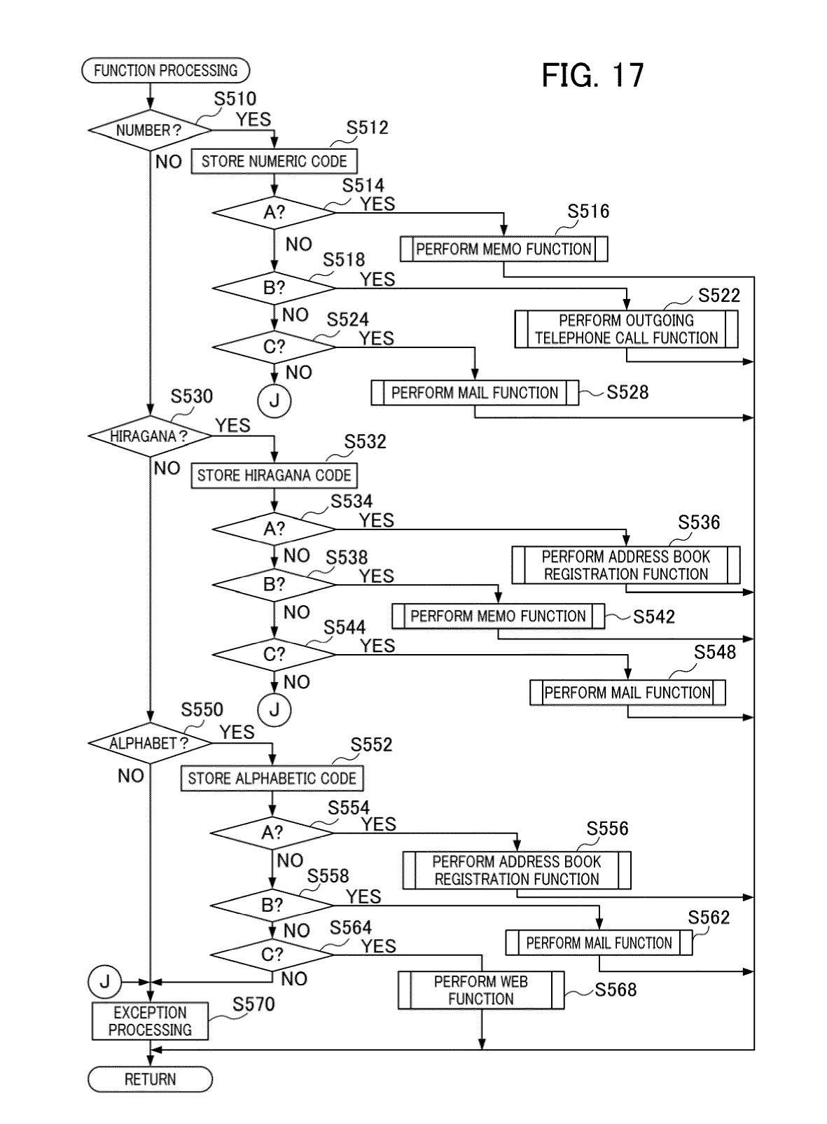

Now with reference to FIG. 17, in Step S510, the main control unit 121 determines whether a “numeric” character is selected as a function type. In a case in which the main control unit 121 determines that a “numeric character” has been selected based on “character type” data read from the work area of the RAM 121b, the processing proceeds to Step S512. In Step S512, the main control unit 121 selects and reads, from a storage area of the RAM 121b, a character code of a “numeric” character type that is displayed on the screen corresponding to this character type, and stores it in a work area of the RAM 121b.

Subsequently, in Step S514, the main control unit 121 functions as a third executing means of the present invention, and determines whether a display position (A) indicating the display area 23a is selected in accordance with selection by way of a function softkey. In a case in which the display position (A) has been selected, the processing proceeds to Step S516, and the main control unit 121 executes a memo function module. In this case, an input operation of a memo text by way of a numeric input can be continued for a numeric character selected as a character type.

On the other hand, in a case in which the display position (A) was not selected in Step S512, the processing proceeds to Step S518, and the main control unit 121 determines whether a display position (B) indicating the display area 23b has been selected in accordance with selection by way of a function softkey. In a case in which the display position (B) has been selected, the processing proceeds to Step S522, and the main control unit 121 executes an outgoing telephone call function module. In this case, a numeric character selected as a character type is used as a telephone number, thereby making it possible to continue an outgoing telephone call operation.

Furthermore, in a case in which the display position (B) was not selected in Step S518, the processing proceeds to Step S524, and the main control unit 121 determines whether a display position (C) indicating the display area 23c has been selected in accordance with selection by way of a function softkey. In a case in which the display position (C) has been selected, the processing proceeds to Step S528, and the main control unit 121 executes the mail function module. In this case, the user can continue an input operation of a mail text by using a numeric character selected as a character type.

In the aforementioned Step S510, in a case in which the main control unit 121 determines that a “numeric” character has not been selected as a character type, the processing proceeds to Step S530, and the main control unit 121 determines whether a “hiragana” character has been selected as a character type. In a case in which the main control unit 121 determines that “hiragana” has been selected based on “character type” data read from the work area of the RAM 121b, the processing proceeds to Step S532.

In Step S532, the main control unit 121 selects and reads, from a storage area of the RAM 121b, a character code of the “hiragana” character type that is displayed on the screen corresponding to this character type, and stores it in a work area of the RAM 121b.

Subsequently, in Step S534, the main control unit 121 determines whether the display position (A) indicating the display area 23a has been selected in accordance with selection by way of a function softkey. In a case in which the display position (A) has been selected, the processing proceeds to Step S536, and the main control unit 121 executes an address book registration function module. In this case, the user can continue an address book registration operation by way of a “hiragana” input to “hiragana” selected as a character type.

On the other hand, in a case in which the display position (A) was not selected in Step S534, the processing proceeds to Step S538, and the main control unit 121 determines whether the display position (B) indicating the display area 23b has been selected in accordance with selection by way of a function softkey. In a case in which the display position (B) has been selected, the processing proceeds to Step S542, and the main control unit 121 executes a memo function module. In this case, to “hiragana” selected as a character type, the user can continue an input operation of a memo text by way of a “hiragana” input.

Furthermore, in a case in which the display position (B) was not selected in Step S538, the processing proceeds to Step S544, and the main control unit 121 determines whether the display position (C) indicating the display area 23c has been selected in accordance with selection by way of a function softkey. In a case in which the display position (C) has been selected, the processing proceeds to Step S548, and the main control unit 121 executes the mail function module. In this case, an input operation of a mail text can be continued by using “hiragana” selected as a character type.

In the aforementioned Step S530, in a case in which the main control unit 121 determines that a “hiragana” character has not been selected as a character type, the processing proceeds to Step S550, and the main control unit 121 determines whether an “alphabetic” character has been selected as a character type. In a case in which the main control unit 121 determines that an “alphabetic” character” has been selected based on “character type” data read from the work area of the RAM 121b, the processing proceeds to Step S552.

In Step S552, the main control unit 121 selects and reads, from a storage area of the RAM 121b, a character code of an “alphabetic” character type that is displayed on the screen corresponding to this character type, and stores it in a work area of the RAM 121b.

Subsequently, in Step S554, the main control unit 121 determines whether the display position (A) indicating the display area 23a has been selected in accordance with selection by way of a function softkey. In a case in which the display position (A) has been selected, the processing proceeds to Step S556, and the main control unit 121 executes the address book registration function module. In this case, the user can continue an address book registration operation by way of an “alphabetic” input to the “alphabetic” character” selected as a character type.

On the other hand, in a case in which the display position (A) was not selected in Step S554, the processing proceeds to Step S558, and the main control unit 121 determines whether the display position (B) indicating the display area 23b has been selected in accordance with selection by way of a function softkey. In a case in which the display position (B) has been selected, the processing proceeds to Step S562, and the main control unit 121 executes the mail function module. In this case, the user can continue a mail address input operation by way of an “alphabetic” input to the “alphabetic” character” selected as a character type.

Furthermore, in a case in which the display position (B) was not selected in Step S558, the processing proceeds to Step S564, and the main control unit 121 determines whether the display position (C) indicating the display area 23c has been selected in accordance with selection by way of a function softkey. In a case in which the display position (C) has been selected, the processing proceeds to Step S568, and the main control unit 121 executes the Web function module. In this case, an input operation of a URL address to a browser can be continued by using an “alphabetic” character selected as a character type.

As described above, in the fourth embodiment, a plurality of different function softkeys are firstly displayed on the standby screen of the cellular telephone device 1 in accordance with one character type selected among a plurality of character types displayed on the screen. Next, desired function processing is executed based on a selected function softkey, and therefore efficient input can be easily performed. Furthermore, in a case in which the selection key of the selection operation key 15 has been depressed, it is possible to obtain a character code corresponding to the color-highlighted area among the character codes that have been input in advance, and therefore a function operation corresponding to the character type can be easily performed.

In addition to the effects of the first to fourth embodiments, it is possible to reduce a period of time required for executing a function intended by the user. For example, even in a case in which the user visually recognizes a license number of a car driving away, by utilizing the mobile terminal device employing the character input method according to the present invention, it is possible to easily record the license number of the car. It should be noted that, in the present invention, the combinations of a character type and a function softkey are not limited to the examples shown in the fourth embodiment, and they may be other appropriate combinations.

### Other Embodiments

Although the standby screen displayed on the display unit 21 is configured, for example, to be split into three areas to display characters in the first to fourth embodiments, the present invention is not limited to such a case. For example, the display control unit 117 may be set such that the standby screen can be split into a plurality of areas such as two or four areas. Even in such a case, efficient character input and function execution are enabled for a split screen, whereby the operability can be improved.

Moreover, although the standby screen displayed on the display unit 21 is configured, for example, to be split into three areas to display characters corresponding to three character types in the first to fourth embodiments, the present invention is not limited to such a case. For example, the character types may be limited such that only “katakana” and “alphabetic” characters can be displayed on the standby screen and “numeric characters” are not displayed, and efficient character input and function execution are enabled for a split screen, whereby operability can be improved. In this case, the main control unit 121 performs this setting, and functions as a setting means of the present invention.

In addition, although the first to fourth embodiments are configured such that the function keys provided to the operation unit side body 2 are used, the present invention is not limited to such a situation. Keys that can be set for functions intended by the user may be provided to the case of the operation unit side body 2 or the display unit side body 3.

Furthermore, although the first to fourth embodiments are configured such that, in order to select character information related to an intended purpose and execute a function thereof, a displayed “alphabetic” character code is used to designate a URL address to connect to a Web site when the “Web” key is depressed, the present invention is not limited to such a case. A configuration may be employed in which an “alphabetic” character code is used to connect to a search site to perform search processing.

Moreover, although simplification of a function invocation for the mail function, the address book function, the Web function and the outgoing telephone call function has been described in the first to fourth embodiments, the present invention is not limited to such a case. In a case in which the mobile terminal device includes a “memo” key, a configuration may be employed in which a memo pad function can be invoked.

1. An input device, comprising:
a first generating unit that generates input information corresponding to at least two input types assigned to a key operated, respectively;
a second generating unit that generates image information corresponding to the input information, respectively; and
a displaying unit that displays an image on a screen which is identical based on the image information, respectively.

2. The input device according to claim 1, further comprising:
a detecting unit that detects that a function key for instructing execution of a predetermined function is operated, the function key corresponding to the image being displayed; and
a first executing unit that executes, based on detection of an operation of the function key, the predetermined function that is based on the input information of the image.

3. The input device according to claim 2, further comprising a first changing unit that changes the predetermined function, based on an operation time of the function key.

4. The input device according to claim 1, further comprising:
a character type selection key for selecting a character type displayed on the screen; and
a second executing unit that executes, in a case in which a character type is selected by an operation of the character type selection key, a predetermined function corresponding to the character type thus selected.

5. The input device according to claim 1, further comprising:
a cursor for selecting a character type displayed on the screen; and
a third executing unit that executes, in a case in which a character type is selected by way of an input from the cursor, a function that is executed together with the character type
wherein the displaying unit that displays a character type as well as a function that is executed in a case in which the character type is selected.

6. The input device according to claim 1, further comprising:
a selecting unit that selects any image among images displayed on the screen;
a second changing unit that changes display of at least one softkey displayed on the screen, based on selection by way of the selecting unit; and
a third executing unit that executes a function of the softkey based on input information of the image thus selected, by way of an operation of a key corresponding to display of the softkeys.

7. The input device according to claim 1, wherein the input types include at least one input type among a hiragana character, a numeric character, an alphabetic character, a katakana character and a symbol.

8. The input device according to claim 1, further comprising a setting unit that sets an input type to be displayed on the screen from among the input types.

9. The input device according to claim 1, wherein a screen that displays the image or a screen that is immediately before displaying the image is a standby screen waiting for an input from a user.
